(19) United States
(12) Patent Application Publication
(10) Pub. No.: US 2011/0132875 A1
(43) Pub. Date: Jun. 9, 2011

(54) SPLATTER RESISTANCE IN CIRCUIT BREAKERS

(75) Inventors: James Miller WERNER, Whitehall, MI (US); James G. MALONEY, Industry, PA (US); Alaa Abdel-Azim ELMOURSI, Troy, MI (US)

(73) Assignee: EATON CORPORATION, Cleveland, OH (US)

(21) Appl. No.: 12/632,185

(22) Filed: Dec. 7, 2009

(51) Int. Cl. H01H 3/02

(52) U.S. Cl. 218/154

(57) ABSTRACT

A circuit breaker includes at least trip mechanism component that has been provided with a splatter resistant surface. The splatter resistant surface significantly reduces the amount of metal splatter that adheres to the component, increasing the reliability of the circuit breaker. The splatter resistant surface may be created by coating the trip mechanism component with a solid lubricant or by applying a solid lubricant to the trip mechanism component in tape form.

### BACKGROUND

Electrical arcing that occurs when a circuit breaker opens causes the metal in the contacts to superheat and become molten metal. The molten metal is propelled by ionized air and gasses throughout the interior of the circuit breaker as the contacts open. Deposits of molten metal, or “splatter”, cool and solidify where they land and may interfere with the functionality of the circuit breaker. For example, the metal deposits may interfere with the motion of mechanical components and prevent proper operation. The metal deposits may also electrically connect circuit breaker components, causing a short circuit.

Often, circuit breakers have design features aimed to mitigate the effects of metal splatter by preventing contact between the metal splatter and circuit breaker components. Some circuit breakers include physical barriers or shields that protect certain components from being contacted by the metal splatter. Other circuit breakers include venting features that attempt to direct the ionized air and gasses and the metal splatter they carry out of the circuit breaker so that the gasses will not propel the metal splatter onto internal circuit breaker components.

### SUMMARY

A circuit breaker is provided that includes a pair of co-operable contacts mechanically moveable between an electrically closed position and an electrically open position and a mechanical linkage coupled to the pair of contacts to move the pair of contacts between the electrically closed and electrically open position. The circuit also includes a trip mechanism responsive to electrical current passing through the pair of contacts to actuate the mechanical linkage when predetermined current conditions are present in current flowing through the pair of contacts. The trip mechanism includes at least one splatter-resistant component that includes a splatter-resistant surface.

### BRIEF DESCRIPTION OF DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic view of an example embodiment of a circuit breaker in an electrically closed, or current conducting, condition.

FIG. 2 is a schematic view of the circuit breaker of FIG. 1 in an electrically open condition.

FIG. 3 is a schematic view of an example embodiment of a circuit breaker that includes a component with a splatter resistant surface.

FIG. 4 is a schematic view of another example embodiment of a circuit breaker that includes a component with a splatter resistant surface.

### DETAILED DESCRIPTION

The circuit breakers described herein include at least trip mechanism component that has been provided with a splatter resistant surface. The splatter resistant surface significantly reduces the amount of metal splatter that adheres to the component, increasing the reliability of the circuit breaker. Thus, rather than attempting to prevent metal splatter from contacting circuit breaker trip mechanism components as has been done with prior art circuit breakers, the circuit breakers described herein prevent the metal splatter from adhering to the component after it has contacted the component.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

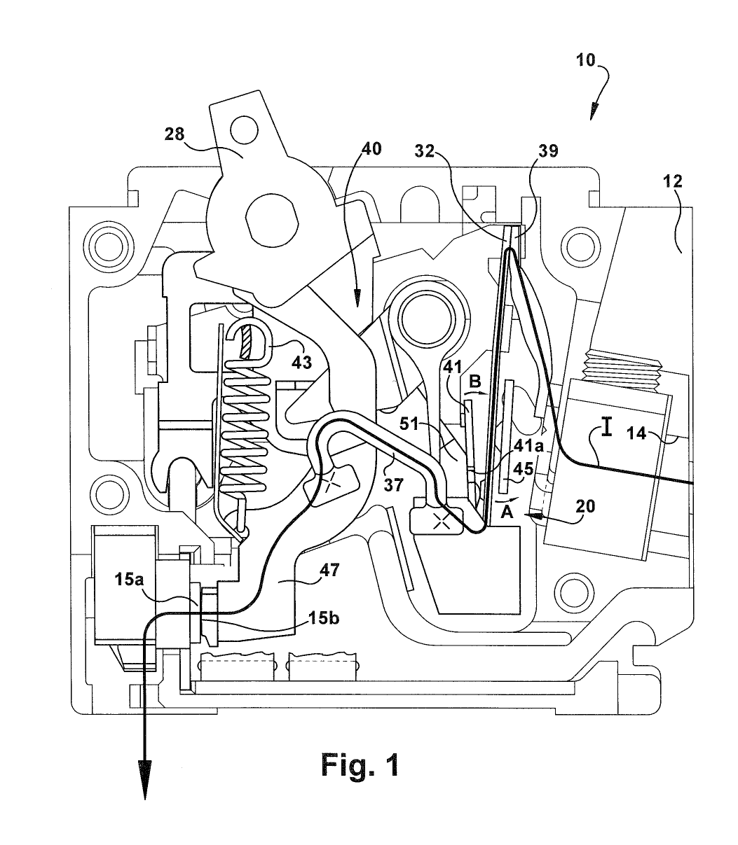

FIG. 1 illustrates an example embodiment of a ground fault circuit breaker 10. The ground fault circuit breaker includes a housing 12 which is composed of electrically insulating material such as a thermosetting resin. The ground fault circuit breaker 10 typically has dimensions of approximately 3 inches in length, 2 inches in height, and 1 inch in width. With those dimensions the circuit breaker 10 is adapted to fit into a conventional load center box and panel cover.

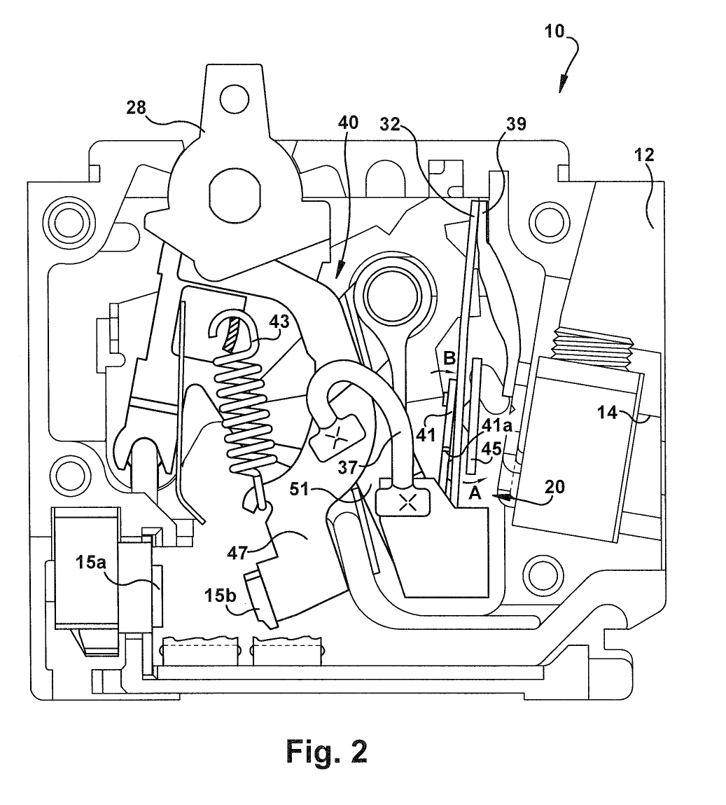

The circuit breaker 10 includes a pair of co-operable contacts 15a, 15b that are moveable between a closed position shown in FIG. 1 and an open position shown in FIG. 2. A mechanical linkage, indicated generally as 40, moves the contacts in response to actuation of a reset lever 28 or operation of a trip mechanism 20. The details of the mechanical linkage 40 and reset lever 28 are not included herein for the sake of brevity. A similar mechanical linkage is described in U.S. Pat. No. 4,081,852, to which a reference is made for a complete description of the structure and operation.

The trip mechanism 20 includes one or more trip mechanism components having characteristics that are altered by the amount and/or character of current flowing through the circuit breaker. In some embodiments, the trip mechanism component is a current carrying member that carries current flowing through the circuit breaker. In the embodiment shown in FIGS. 1-3, the trip mechanism 20 includes a bimetal device 32 that is a flat member secured at an upper end to a stationary housing projection 39. A lower end of the bimetal device 32 is not anchored and is free to deflect in a direction indicated by the arrow labeled “A” in FIG. 1. When the bimetal device 32 is cold, it takes the straightened position shown in FIG. 1. When the bimetal heats, it deflects in the direction shown by the arrow “A”. The bimetal device is selected to have deflection properties that provide proper circuit breaker operation at expected operating currents and to actuate the mechanical linkage when current levels exceed an acceptable level, as will be explained in more detail below. While the trip mechanism 20 illustrated in FIGS. 1-4 includes a bimetal device 32, it will be understood by one of skill in the art that the trip mechanism may employ other devices, such as, for example, magnets, solenoids, and so on.

In FIG. 1, current flow is indicated by the heavy arrow “I”. Current enters the circuit breaker through an entrance 14 on a conductor (not shown). The current flows through the bimetal device 32, a flexible conductor 37, and a moving arm 47 that carries the moving contact 15b. In its straightened position, the bimetal 32 supports a moveable armature 41 in the position shown in FIG. 1. The armature 41 includes a latch surface 41a that engages a latch member 51. The latch member holds the mechanical linkage 40 against the biasing force of a spring 43 that urges the mechanical linkage 40 to the open contact position shown in FIG. 2. During normal operation, deflection of the bimetal device 32 due to current flow is not sufficient to allow the latch member 51 to disengage the latch surface 41a of the armature and rotate in a clockwise direction to the open position.

When an overcurrent condition exists the bimetal further deflects, moving the armature 41 and its latch surface 41a out of engagement with the latch member 51. The mechanical linkage is then urged by the spring into the open position shown in FIG. 2. In some embodiments, the circuit breaker 10 includes a ground fault detection feature that opens the contacts in response to a sudden spike in current. A magnetic member 45 is placed in proximity to the bimetal 32. The current in the bimetal 32 induces a magnetic force in the magnetic member 45. When the current reaches a predetermined level, the magnetic force becomes sufficient to move the armature 41 in the direction indicated by the arrow “B”. This motion pulls the latch surface 41a out of engagement with the latch member 51 to allow the contacts to open as shown in FIG. 2.

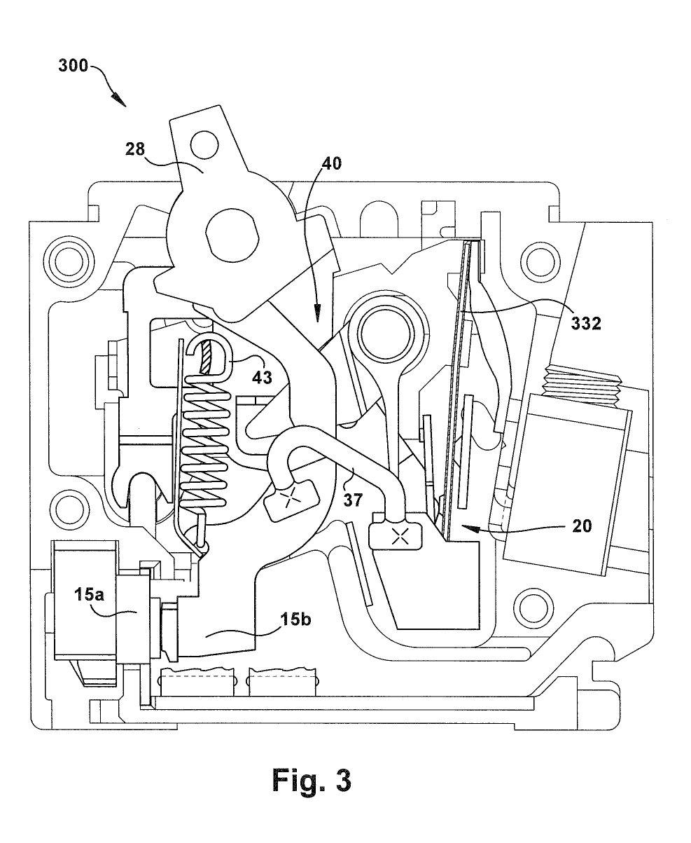

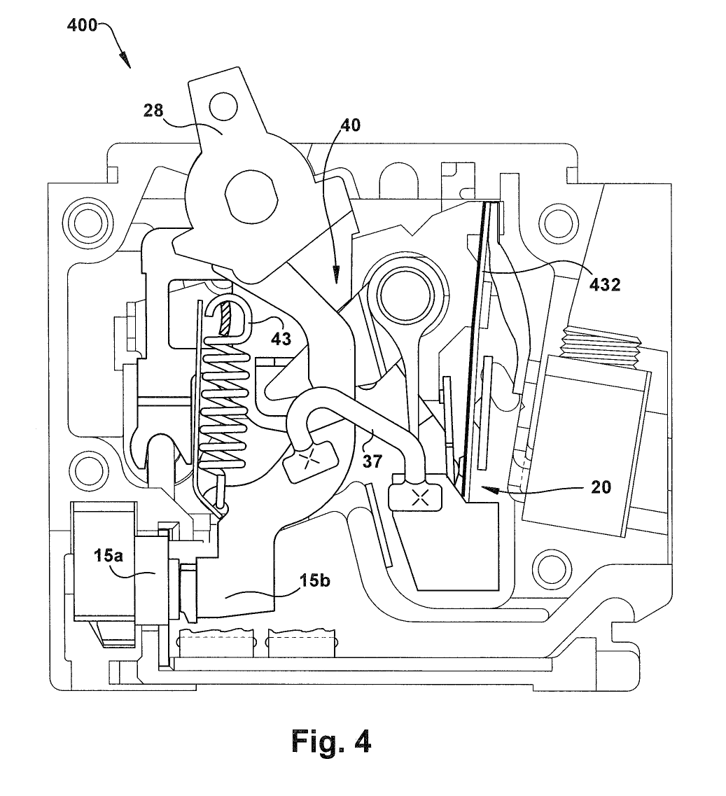

FIGS. 3 and 4 illustrate example embodiments of circuit breakers 300, 400 that have a trip mechanism component that includes at least one splatter resistant surface. A splatter resistant surface repels metal splatter such that the splatter does not tend to adhere to the surface. FIG. 3 is a schematic diagram of an embodiment of a circuit breaker 300 that includes a bimetal device 332. The bimetal device 332 has a splatter resistant coating. The splatter resistant coating may be a solid lubricant. Example solid lubricants include Boron Nitride, Molybdenum Disulfide, fluoropolymer, and graphite.

Various solid lubricants were tested for suitability as a splatter resistant surface. A twin-wire arc gun was used to generate a metal splatter and appropriate spray parameters were established to generate splatter from Copper, 316 Stainless Steel, and Tungsten wires. The twin-wire arc thermal spray device sprayed on bimetal strips mounted on a steel plate and placed 10 feet away from the gun nozzle. Some of the bimetal strips were electroplated with tin, as is common with such devices. Other bimetal devices were not electroplated. Due to the low melting point of tin, it may be advantageous to select splatter resistant coating that has a lower cure temperature than the melting point of tin, which is 232 C.

Testing was performed on bimetal devices coated with various types of solid lubricants. The solid lubricant coatings were suspended in a liquid solution and deposited by an aerosol spray onto the bimetal device. Along with plated and unplated control samples, the testing included bimetal devices coated with Boron Nitride supplied by ZYP Coatings, Super Enhanced Graphite supplied by ZYP Coatings, low-temperature cure fluoropolymer manufactured by Sun Coating, and low-temperature cure fluoropolymer manufactured by Secoa. The fluoropolymer coatings that were tested are blends of resins and fluoropolymer lubricants.

Metal splatter of Copper and Stainless Steel was collected for 12 seconds on the bimetal device samples. Metal splatter of Tungsten was collected for 3 seconds on the bimetal device samples. After being sprayed with metal splatter, the bimetal strips were optically analyzed and a splatter count and splatter coverage was determined with respect to each metal component of the splatter. To determine the splatter count, each sample was scanned at 30× with oblique lighting to count metal splatter particles. To determine the splatter coverage, a 50× microphotograph of the greatest splatter particle area was taken. The image was analyzed to measure the total area of splatter coverage from each photo. Splatter coverage was determined to provide a better indicator of splatter resistance.

The Super Enhanced Graphite and fluoropolymer coatings all provided significant improvement in splatter resistance as compared to the uncoated control samples. Thus, any of these materials, as well as other splatter resistant coatings, may be selected, depending on cost and manufacturing considerations.

FIG. 4 illustrates an alternative embodiment of a circuit breaker 400 with a trip mechanism component that includes a splatter resistant surface. The circuit breaker 400 includes a bimetal device 432 having solid lubricant carrying tape adhered to one side. The solid lubricant carrying tape may be, for example Teflon® tape. Both 2 and 3 mil Teflon® tape were tested according to the procedure outlined in connection with FIG. 3. Two mil Teflon® tape performed better than 3 mil tape and all of the solid lubricant aerosol coatings. Teflon® tape is a cost effective alternative to coatings, but may present manufacturing challenges in applying the tape to the bimetal device.

In other embodiments, other circuit breaker components may include a splatter resistant surface instead of or in addition to trip mechanism components. For example, the spring 43 or other mechanical linkage components may be adapted to include a splatter resistant surface.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

We claim:

1. A circuit breaker comprising:
a pair of co-operable contacts mechanically moveable between an electrically closed position and an electrically open position;
a mechanical linkage coupled to the pair of contacts to move the pair of contacts between the electrically closed and electrically open position;
a trip mechanism responsive to electrical current passing through the pair of contacts to actuate the mechanical linkage when predetermined current conditions are present in current flowing through the pair of contacts; and
wherein the trip mechanism comprises at least one splatter-resistant component that includes a splatter-resistant surface.

2. The circuit breaker of claim 1 where the splatter-resistant component comprises a bimetal device that deflects in response to thermal heating caused by current flowing through the bimetal device to the pair of contacts.

3. The circuit breaker of claim 1 where the splatter resistant surface comprises a solid lubricant.

4. The circuit breaker of claim 3 where the splatter resistant surface comprises a fluoropolymer.

5. The circuit breaker of claim 1 where the splatter resistant surface is created by spraying a coating on the splatter resistant component.

6. The circuit breaker of claim 1 where the splatter resistant surface is created by applying a tape to the splatter resistant component, where the tape has a splatter resistant surface.

7. The circuit breaker of claim 1 where the splatter resistant component carries current flowing through the pair of contacts when the pair of contacts is in the electrically closed position.

8. The circuit breaker of claim 1 where at least one mechanical linkage component includes a splatter resistant surface.

9. The circuit breaker of claim 8 where the at least one mechanical linkage component comprises a spring.

10. An apparatus comprising:
a conductive member adapted to carry current flowing through a circuit breaker device, where the conductive member comprises a splatter resistant surface.

11. The apparatus of claim 10 where the splatter resistant surface comprises a solid lubricant.

12. The apparatus of claim 11 where the splatter resistant surface comprises a fluoropolymer.

13. The apparatus of claim 10 where the splatter resistant surface is created by spraying a coating on the conductive member.

14. The apparatus of claim 10 where the conductive member is a bimetal device.

15. The apparatus of claim 10 where the splatter resistant surface is created by applying a tape to the conductive member, where the tape has a splatter resistant surface.
